(19) United States
(12) Patent Application Publication
(10) Pub. No.: US 2005/0271806 A1
(43) Pub. Date: Dec. 8, 2005

(54) Dispenser and method for non-contact dispensing of adhesive

(75) Inventors: Charles P. Ganzer, Cumming, GA (US); Leslie J. Varga, Cumming, GA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation

(21) Appl. No.: 11/000,803

(22) Filed: Dec. 1, 2004

Related U.S. Application Data
(63) Continuation-in-part of application No. 10/860,300, filed on Jun. 3, 2004.

(51) Int. Cl. B05D 5/00

(52) U.S. Cl. 427/207.1; 427/286; 118/300

(57) ABSTRACT

A method for dispensing an adhesive to a substrate without contact between the adhesive dispenser and the substrate. The method includes spacing the liquid discharge outlets of a dispensing nozzle above a substrate, moving the substrate beneath the outlets, opening a valve to dispense a series of spaced apart adhesive beads from the outlets, coalescing the beads to form a film layer, and closing the valve to stop the flow of adhesive from the nozzle.

This application is a continuation-in-part application of U.S. Ser. No. 10/860,300, pending, which was filed on Jun. 3, 2004, and the disclosure of which is hereby fully incorporated by reference herein.

### FIELD OF THE INVENTION

The present invention relates generally to liquid material dispensing systems, and more particularly to a method for dispensing hot melt adhesive.

### BACKGROUND OF THE INVENTION

Cardboard boxes and other containers are conventionally manufactured by applying adhesive, in the form of elongate beads or swirled patterns, to flaps and other areas of a cardboard blank using liquid adhesive dispensing equipment. The box structure is then erected and the adhesive coated portions of the blank are engaged with mating portions of the blank to form a carton. Typically, the adhesive is applied to the blank and the carton is erected at the location where the carton will be used. In some applications, however, it may be desired to apply a thermoplastic adhesive, such as a thermoplastic hot melt adhesive, to a cardboard blank so that the blank may be stored or transported in a collapsed form until the carton is needed. Thereafter, the adhesive can be softened to a tacky state, such as by the application of heat and/or radiation, and the carton erected without the need for adhesive dispensing equipment at the erection site. For best results, thermoplastic adhesives may be dispensed to the cardboard surfaces in thin, wide layers (i.e. a film) so that the adhesive can quickly cure or solidify after being applied to the carton blank, and later be softened to a tacky state and used to adhesively secure flaps on the carton.

Conventional dispensing devices for applying adhesives in thin, wide layers include slot-type applicators. These slot-type applicators apply adhesive by contacting the substrate and therefore may not be suitable for all applications. For example, contact between a slot-type applicator and various surface features such as score lines, fold lines, and flaps of an unerected carton blank may scuff, tear, or otherwise damage the carton material. Moreover, contact between the applicator and an abrasive or rough surface such as cardboard tends to prematurely wear the dies of the applicator.

A need therefore exists for a system and method of dispensing adhesive material in thin, wide layers to substrate materials, such as cardboard, and which addresses drawbacks of the prior art, such as those discussed above.

### SUMMARY OF THE INVENTION

The present invention provides an adhesive dispensing system and method for applying a film layer of adhesive material onto a substrate without contacting the substrate. The method includes spacing the liquid discharge outlets of a dispensing gun above the substrate, opening a valve to dispense a plurality of adhesive beads to the substrate, coalescing the adhesive beads to form a film layer, and closing the valve to stop the flow of adhesive from the outlets. In one embodiment, the outlets of the dispensing are formed through a dispensing surface having a surface finish less than approximately 32 micro-inches. In another embodiment, an edge defined by the intersection of the outlets and the dispensing surface is free from visible features or defects when viewed at a magnification of not more than ten power.

In another embodiment, the method further includes creating a negative pressure when the valve is closed to stop the flow of adhesive, so that that excess adhesive is prevented from dripping onto the substrate. In the various embodiments of this invention, the adhesive utilized may be a thermoplastic or a thermoset adhesive, depending on the needs of the application. For example, a thermoplastic adhesive may be applied to the substrate, such as a cardboard blank for forming a carton, and allowed to cure or solidify. The blank may then be stored or transported in a collapsed condition until such time as it is desired to form the carton, whereafter the adhesive may be softened to a tacky state, for example, by the application of heat and/or radiation. In this tacky state, the adhesive may be used, as per typical procedures, to secure portions of the carton together during carton formation and sealing.

In another embodiment, a dispenser for dispensing a plurality of spaced apart adhesive filaments such that the filaments coalesce to form a thin, wide layer of adhesive includes an adhesive manifold, a liquid dispensing module coupled to the manifold, and a nozzle coupled to the liquid dispensing module. The nozzle has a dispensing surface with a surface finish of less than approximately 32 micro-inches and which is adapted to be spaced above a moving substrate. Heated liquid adhesive material flows from the manifold through the module and is dispensed as adhesive filaments to the substrate from a plurality of liquid discharge outlets formed through the dispensing surface.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a side elevation view, depicting an exemplary dispenser according to the present invention;

FIG. 2A cross-section view of the nozzle of FIG. 2B, taken along line 2A-2A;

FIG. 2B is bottom view taken along line 2B-2B of FIG. 1 and depicting an exemplary nozzle arrangement according to the present invention;

FIG. 3 is a top plan view of a layer of adhesive material dispensed from the dispenser of FIG. 1; and

FIG. 4 is a perspective view of the adhesive material of FIG. 3.

### DETAILED DESCRIPTION

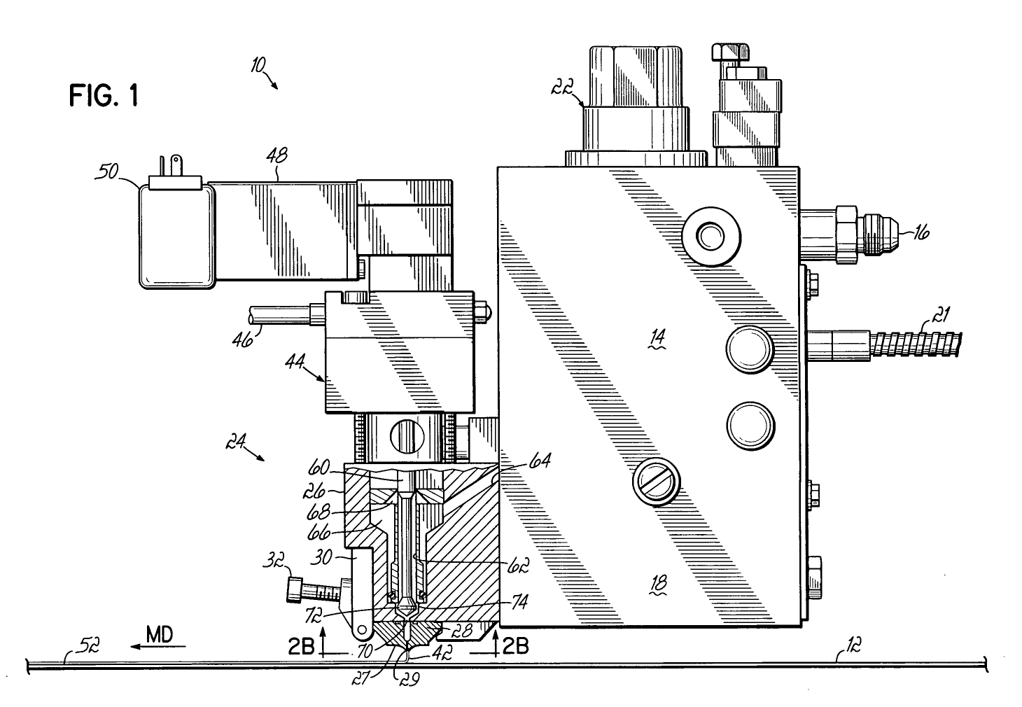

Referring now to FIG. 1, an exemplary adhesive dispenser 10 applies a film of adhesive to a substrate 12, according to the present invention. The dispenser 10 includes an adhesive manifold 14 for receiving and heating liquid adhesive material from an adhesive supply, as known in the art. In particular, liquid adhesive material enters the adhesive manifold 14 through an adhesive inlet 16. Control cable 21 is coupled to the adhesive manifold 14 to control the heating of the adhesive. A filter assembly 22 coupled to the adhesive manifold 14 filters contaminants from the incoming adhesive material.

Dispenser 10 further includes a liquid dispensing module or gun 24 coupled to the adhesive manifold 14 to receive heated liquid material, such as hot melt adhesive, therefrom. The module 24 includes a module body 26 and a nozzle or die 28 coupled to the module body 26 for dispensing the liquid adhesive material to the substrate 12. The nozzle 28 may be a commercially available nozzle, such as a Summit™ nozzle, a Control Seam™ nozzle, or a C-F™ nozzle available from Nordson Corporation of Westlake, Ohio. Alternatively, the nozzle may be custom designed to suit the particular application, as may be desired. The module body 26 includes one or more liquid material passages formed therethrough for directing liquid adhesive material from the adhesive manifold 14 to the nozzle 28, as known in the art and described in more detail below. In the embodiment shown, the nozzle 28 is coupled to the module body 26 by a quick release clamp 30 and a threaded fastener 32 for quick and easy replacement of the nozzle 28.

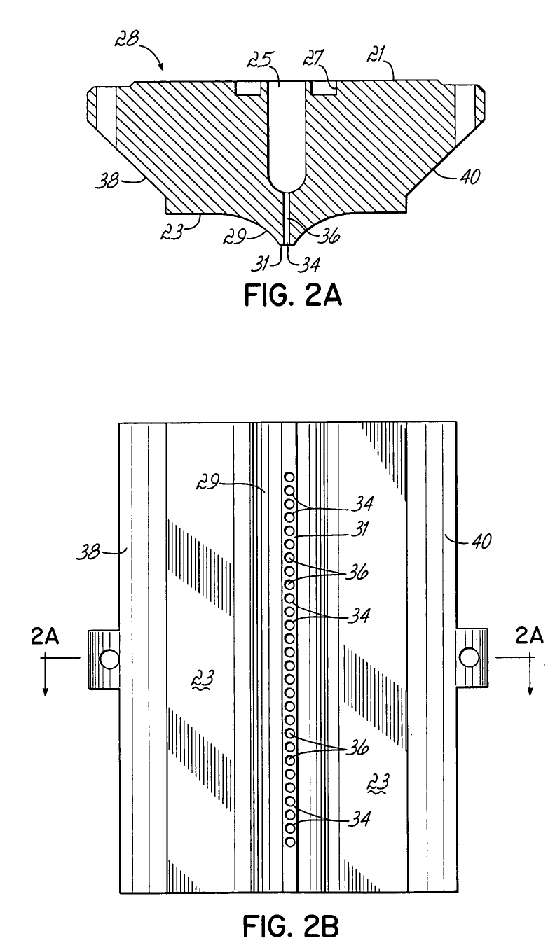

Referring now to FIGS. 2A and 2B, the nozzle 28 is shown in greater detail. In this embodiment, the nozzle 28 has a generally trapezoidal shape with generally flat upper and lower surfaces 21, 23. The nozzle further includes tapered front and rear surfaces 38, 40 that facilitate securing the nozzle 28 to the module body 26. An elongate liquid reservoir 25 is formed into the upper surface 21 for receiving liquid adhesive from the module body 26, as described more fully below. A circumferential groove 27 formed into the upper surface 21 is adapted to receive a sealing member, such as an O-ring (not shown), to thereby seal the interface between the upper surface 21 and the module body 26.

A raised ridge 29 extends downwardly from the lower surface 23 and terminates in a generally flat dispensing surface 31. A series of spaced apart liquid discharge outlets 34 are formed through dispensing surface 31 and communicate with the liquid reservoir 25 via passages 36 extending therebetween. In one embodiment, the liquid discharge outlets 34 are spaced apart approximately 0.016 inch to approximately 0.072 inch. The liquid discharge outlets 34 are disposed across the width of the nozzle 28, transverse to the machine direction MD of the substrate 12. Accordingly, liquid material is dispensed from the liquid discharge outlets 34 in the form of a series of spaced apart beads 42, as will be described more fully below.

In the embodiment shown in FIGS. 2A and 2B, the outlets 34 are aligned in a generally linear arrangement extending transverse to the machine direction MD. It will be recognized, however, that the outlets 34 may alternatively be arranged in a curvilinear pattern, or along other directions, as may be desired. In one embodiment, the outlets have a diameter of approximately 0.01 inch and are spaced approximately 0.072 inch apart. In other applications, the outlets may have diameters of approximately 0.004 inch to approximately 0.032 inch, or even other diameters, as may be desired. It will be recognized that the outlets may have other configurations and/or spacing arrangements to suit particular applications.

The dispensing surface 31 is manufactured to have a very smooth finish, such as between approximately 2 and 32 micro-inches. In another embodiment, the surface finish is approximately 8 micro-inches to 16 micro-inches. In yet another embodiment, the surface finish is approximately 8 micro-inches or less.

In another embodiment, the intersection of the outlets 34 with the dispensing surface 31 is not chamfered or otherwise radiused. Rather, the intersection defines a smooth, continuous, or unbroken edge such that no appreciable features or defects are present to interact with the liquid material dispensed from outlets 34, thereby improving the quality of the filaments of dispensed liquid material. In one embodiment, the edges defined by the intersection of the outlets 34 with the dispensing surface 31 are free of visible features or defects such as chamfers, radii, scratches or burrs when viewed at a magnification of ten power, or less.

Applying a smooth surface finish to surface 31 is one way to better define the edges or corners of outlets 34 about their circumferences. The surface finish is provided by grinding and lapping operations that are familiar to persons of ordinary skill in the art. The outlets 34 are not chamfered or otherwise radiused in accordance with this embodiment of the invention. The invention contemplates that only the portions of surface 31 locally surrounding the outlets 34 may have the prescribed smooth surface finish, as opposed to the entire surface 31. The smooth, continuous and unbroken edge of the outlets 34 have no appreciable features that interact with the liquid material dispensed from the outlets 34. This improves the character of the streams of dispensed liquid material.

With continued reference to FIG. 1, the adhesive dispenser 10 further includes an on/off type valve 44 for selectively turning on and shutting off the liquid material dispensed from the nozzle 28. In the embodiment shown, the valve 44 is configured to provide “snu ff back” control of the liquid material dispensed from the nozzle to prevent stringing or dripping of the liquid material, as described in U.S. Pat. Nos. 6,688,580; 5,733,597; and 5,078,168, assigned to the assignee of the present invention. An exemplary snuff back-type valve 44 is part number 206061 available from Nordson Corporation of West Lake, Ohio. The valve 44 is provided with pressurized air through a supply line 46 and is controlled by a solenoid 48 coupled to a controller (not shown) through connector 50.

Valve 44 includes a plunger rod 60 that extends through a valve passage 62 formed into module body 26. Adhesive material from the adhesive manifold 14 enters module body 26 through an adhesive inlet passage 64. Adhesive inlet passage 64 communicates with valve passage 62 through an adhesive cavity 66 and connecting passages 68. When plunger rod 60 is actuated in a downward direction, pressurized adhesive material flows through the adhesive inlet passage 64, adhesive cavity 66, and connecting passages 68 to the valve passage 62 and through outlet passage 70 into the nozzle 28 to be dispensed from outlets 42 onto substrate 12.

When it is desired to stop the flow of adhesive, plunger rod 60 is activated in an upward direction and rod end 72 seals against valve seat 74. The movement of plunger rod 60 away from outlet passage 70 creates a negative pressure that draws a small amount of adhesive back through nozzle 28 to thereby prevent drips of adhesive material being dispensed to substrate 12.

As depicted in FIG. 1, substrate 12 is moved past the nozzle 28 in the machine direction MD, while liquid adhesive material is dispensed from the nozzle 28 to the substrate 12. Advantageously, the liquid discharge outlets 34 of the nozzle 28 are spaced above the substrate 12 to avoid contact between the substrate 12 and the dispenser 10. In one embodiment, the liquid discharge outlets 34 are spaced approximately 0.075 inch to 0.40 inch above the surface of the substrate 12.

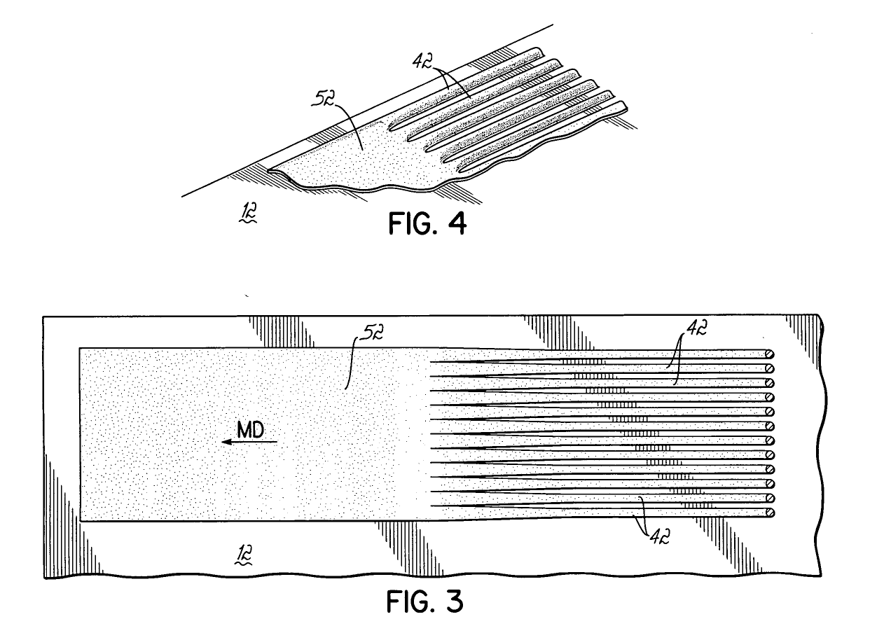

Referring now to FIGS. 3 and 4, the liquid material dispensed from the nozzle 28 is applied to the substrate 12 as a series of spaced apart beads 42 which subsequently coalesce to form a thin, wide layer, or film of adhesive 52 on the substrate. In one embodiment, the adhesive film layer formed on the substrate has a thickness of about 0.005 inch to 0.020 inch and a width of about 1.5 inch to 4.0 inches, however, it will be recognized that the thickness and width of the film layer may vary depending on the application. The nozzles 28 can be ganged together, and staggered to eliminate gaps in the orifice spacing of adjacent nozzles, to provide even greater widths of dispensed adhesive. In another embodiment, the film layer has an aspect ratio of about 0.001 to 0.013.

Because the nozzle does not contact the substrate, the dispenser 10 is able to apply the liquid adhesive material at relatively high line speeds, such as approximately 500 to 2000 feet per minute. Accordingly the dispenser 10 is particularly suited to high frequency dispensing, and can dispense up to 85,000 beads per hour. After a desired amount of adhesive has been applied, solenoid 48 actuates the valve 44 to shut off the supply of adhesive and create a negative pressure that prevents adhesive in the module 24 from dripping onto the substrate 12, as described above.

Using the adhesive dispenser 10, a method of dispensing adhesive onto a substrate 12 includes spacing the liquid discharge outlets 34 of an adhesive dispensing module 24 a distance above a substrate surface, moving the substrate 12 beneath the liquid discharge outlets 34, opening a valve to dispense adhesive onto the substrate 12 in the form of a film layer 52, and closing the valve 44 to stop dispensing adhesive to the substrate 12. The adhesive is initially dispensed from the module 24 as a plurality of spaced apart adhesive beads 42. The adhesive beads 42 on the substrate 12 coalesce to form the film layer 52. The method may further include creating a vacuum when the valve 44 is closed such that excess adhesive does not drip from the nozzle 28 to the substrate 12.

In one embodiment, the dispenser 10 and method of the present invention may be used to apply film layers 52 of adhesive to selected surfaces of a substrate 12, such as flaps of cardboard blanks for forming cartons, or any other substrate where it is desired to deposit a thin film of adhesive without contacting the substrate. Various formulations of thermoplastic adhesive may be used, such as conventional ethylene vinyl acetate hot melt adhesives or other adhesives. After the adhesive solidifies, the cardboard blanks may be stored and shipped in the flat, unerected condition. When a carton is subsequently required, the cardboard blanks may then be erected and the adhesive softened to a tacky state, such as by application of heat or radiation to the film layers 52. The adhesive-coated flaps may thereafter be engaged with portions of adjacent flaps or other surfaces of the erected blank, to secure and/or seal the cartons in the erected condition.

While dispenser 10 has been shown and described above in an embodiment wherein adhesive is applied to cardboard blanks for forming cartons, it will be recognized that the dispenser 10 may be used in various other applications to apply a thin layer of adhesive or other liquid material to a substrate without contacting the surface of the substrate. Applying adhesive in this manner may be desirable, for example, when the surface is rough or abrasive, or when the surface has features or a fine finish that might be damaged by contact with a conventional slot-type nozzle.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

1. A method of dispensing adhesive to a substrate, comprising:
providing an adhesive dispensing gun having a plurality of spaced apart liquid discharge outlets formed into a dispensing surface having a surface finish less than approximately 32 micro-inches
spacing the liquid discharge outlets of the adhesive dispensing gun a distance above a substrate surface;
moving the substrate beneath the gun;
dispensing a plurality of spaced apart adhesive beads from the outlets; and
coalescing the adhesive beads to form a film layer on the substrate surface.

2. The method of claim 1, further comprising:
opening a valve on the gun to dispense the plurality of adhesive beads;
closing the valve to stop dispensing the adhesive beads; and
creating a negative pressure when the valve is closed to prevent excess adhesive from dripping onto the substrate surface.

3. The method of claim 1, wherein the substrate is moved beneath the gun at a rate of approximately 500 feet per minute to 2000 feet per minute.

4. The method of claim 1, wherein the formed adhesive film layer has a thickness of approximately 0.005 inch to 0.020 inch.

5. The method of claim 1, wherein the formed adhesive film layer has a width of approximately 1.5 inch to approximately 4 inches.

6. The method of claim 1, wherein the liquid discharge outlets are spaced approximately 0.075 inch to approximately 0.40 inch above the substrate surface.

7. The method of claim 1, wherein the formed adhesive film layer has an aspect ratio of approximately 0.001 to approximately 0.013.

8. The method of claim 1, wherein the liquid discharge outlets are spaced apart approximately 0.016 inch to approximately 0.072 inch.

9. A method of dispensing adhesive to a substrate, the method comprising:
providing an adhesive dispensing gun having a plurality of spaced apart liquid discharge outlets formed into a dispensing surface, the dispensing gun further including an edge defined by the intersection of the liquid discharge outlets and the dispensing surface that is free from visible features or defects when viewed at a magnification of not more than ten power;
spacing the liquid discharge outlets of the adhesive dispensing gun a distance above a substrate surface;
moving the substrate beneath the gun;
dispensing a plurality of spaced apart adhesive beads from the outlets; and
coalescing the adhesive beads to form a film layer on the substrate surface.

10. The method of claim 9, further comprising:
opening a valve on the gun to dispense the plurality of adhesive beads;
closing the valve to stop dispensing the adhesive beads; and
creating a negative pressure when the valve is closed to prevent excess adhesive from dripping onto the substrate surface.

11. The method of claim 9, wherein the formed adhesive film layer has a thickness of approximately 0.005 inch to 0.020 inch.

12. The method of claim 9, wherein the formed adhesive film layer has a width of approximately 1.5 inch to approximately 4 inches.

13. The method of claim 9, wherein the formed adhesive film layer has an aspect ratio of approximately 0.001 to approximately 0.013.

14. A dispenser for dispensing a plurality of spaced apart, continuous filaments of adhesive material to a moving substrate such that the filaments coalesce to form a thin, wide layer of adhesive, the dispenser comprising:
an adhesive manifold adapted to heat liquid adhesive material from a supply;
a liquid dispensing module coupled to said adhesive manifold and having at least one fluid passage communicating with said adhesive manifold to receive adhesive material therefrom; and
a nozzle coupled to said module, said nozzle comprising a dispensing surface adapted to be spaced above the moving substrate and a plurality of spaced apart liquid discharge outlets formed through said dispensing surface for dispensing the adhesive filaments to the substrate, said dispensing surface having a surface finish of less than approximately 32 micro-inches.

15. The dispenser of claim 14, wherein said dispensing surface has a surface finish of approximately 8 micro-inches to approximately 16 micro-inches.

16. The dispenser of claim 14, wherein said dispensing surface has a surface finish of not more than 8 micro-inches.

17. The dispenser of claim 14, further comprising:
an edge defined by the intersection of said liquid discharge outlets and said dispensing surface, said edge being free from visible features or defects when viewed at a magnification of not more than ten power.

18. A dispenser for dispensing a plurality of spaced apart, continuous filaments of adhesive material to a moving substrate such that the filaments coalesce to form a thin, wide layer of adhesive, the dispenser comprising:
an adhesive manifold adapted to heat liquid adhesive material from a supply;
a liquid dispensing module coupled to said adhesive manifold and having at least one fluid passage communicating with said adhesive manifold to receive adhesive material therefrom; and
a nozzle coupled to said module, said nozzle comprising:
a dispensing surface adapted to be spaced above the moving substrate,
a plurality of spaced apart liquid discharge outlets formed through said dispensing surface for dispensing the adhesive filaments to the substrate, and
an edge defined by an intersection of said liquid discharge outlets and said dispensing surface, said edge being free from visible features or defects when viewed at a magnification of not more than ten power.
